(19) United States
(12) Patent Application Publication
(10) Pub. No.: US 2026/0164472 A1
(43) Pub. Date: Jun. 11, 2026

(54) BANDWIDTH PART PROCESSING METHOD AND APPARATUS

(71) Applicant: HUAWEI TECHNOLOGIES CO., LTD., Shenzhen (CN)

(72) Inventors: Yunfei QIAO, Hangzhou (CN); Jiayin ZHANG, Shanghai (CN); Xiaolei TIE, Shanghai (CN); Yu WANG, Hangzhou (CN); Tianhang YU, Hangzhou (CN)

(21) Appl. No.: 19/182,139

(22) Filed: Apr. 17, 2025

Related U.S. Application Data
(63) Continuation of application No. PCT/CN2023/120900, filed on Sep. 23, 2023.

(30) Foreign Application Priority Data
Oct. 18, 2022 (CN) 202211274820.0

(51) Int. Cl. H04W 74/0833; H04B 7/06; H04W 72/23

(52) U.S. Cl. CPC H04W 74/0833; H04B 7/06964; H04W 72/23

(57) ABSTRACT

Example bandwidth part (BWP) processing methods and apparatus are described. One example method includes sending, by a terminal device, a bandwidth part switching request by using a first random access resource, where the first random access resource is associated with a first standby BWP set, and a coverage enhancement level of a standby BWP in the first standby BWP set is higher than a coverage enhancement level of a serving BWP of the terminal device. The terminal device receives first indication information, where the first indication information indicates a first standby BWP, and the first standby BWP is a standby BWP in the first standby BWP set.

### CROSS-REFERENCE TO RELATED APPLICATIONS

This application is a continuation of International Application No. PCT/CN2023/120900, filed on Sep. 23, 2023, which claims priority to Chinese Patent Application No. 202211274820.0, filed on Oct. 18, 2022. The disclosures of the aforementioned applications are hereby incorporated by reference in their entireties.

### TECHNICAL FIELD

This application relates to the field of communication technologies, and in particular, to a bandwidth part processing method and an apparatus.

### BACKGROUND

In a cellular network, a terminal device may be covered by a plurality of beams. When a current serving beam fails, the terminal device may select an appropriate candidate beam from a configured beam recovery candidate set, and initiate a beam recovery request to a network device, to request to switch from the current serving beam to the candidate beam, for beam recovery.

However, for a non-terrestrial network (NTN) scenario, the terminal device cannot be covered by a plurality of beams in most cases. Consequently, when the current serving beam fails, the terminal device cannot perform beam recovery by selecting the candidate beam, resulting in communication interruption.

### SUMMARY

Embodiments of this application provide a bandwidth part processing method and an apparatus, to help maintain communication continuity.

According to a first aspect, an embodiment of this application provides a bandwidth part processing method, and the method may be applied to a terminal device (for example, a device or a chip of the terminal device). In the method, the terminal device sends a bandwidth part BWP switching request by using a first random access resource. The first random access resource is any one of one or more dedicated random access resources, the first random access resource is associated with a first standby BWP set, and a coverage enhancement level of a standby BWP in the first standby BWP set is higher than a coverage enhancement level of a serving BWP of the terminal device. The terminal device receives first indication information, where the first indication information indicates a first standby BWP, and the first standby BWP is a standby BWP in the first standby BWP set.

In this embodiment of this application, the terminal device sends the BWP switching request by using any one of the one or more dedicated random access resources, to obtain the first standby BWP whose coverage enhancement level is higher than the coverage enhancement level of the serving BWP. This helps the terminal device switch from the serving BWP to the first standby BWP when the serving BWP fails or beam recovery fails, thereby helping maintain communication continuity.

In an optional implementation, when determining that the serving BWP fails or beam recovery fails, the terminal device sends the bandwidth part BWP switching request by using the first random access resource, to request to switch the serving BWP.

When the serving BWP of the terminal device fails, the terminal device cannot continue to use the serving BWP for communication, and needs to request to switch the serving BWP. When the terminal device fails to perform beam recovery, the terminal device cannot continue to perform communication by using a serving BWP corresponding to a serving beam. Therefore, the terminal device also needs to request to switch the serving BWP.

In another optional implementation, when receiving a physical downlink control channel PDCCH, the terminal device sends the bandwidth part BWP switching request by using the first random access resource. The PDCCH is used to trigger the terminal device to send the BWP switching request by using a dedicated random access resource. In this manner, after being triggered by the PDCCH, the terminal device sends the bandwidth part BWP switching request by using the first random access resource, to request to switch the serving BWP.

In an optional implementation, the terminal device may further receive configuration information, where the configuration information includes one or more standby BWP sets and a dedicated random access resource associated with each of the one or more standby BWP sets, and each of the standby BWP sets includes one or more standby BWPs.

It can be learned that one or more standby BWP sets are configured for the terminal device, so that when the serving BWP fails or beam recovery fails, the terminal device may select one standby BWP set from the one or more standby BWP sets to initiate the BWP switching request. In addition, dedicated random access resources associated with the one or more standby BWP sets are further configured for the terminal device, so that the network device determines, by using the dedicated random access resource used by the terminal device to send the BWP switching request, the standby BWP set selected by the terminal device, and the network device determines, from the standby BWP set selected by the terminal device, a standby BWP to which the terminal device can switch.

In an optional implementation, if the terminal device sends the BWP switching request by using the first random access resource only when receiving the PDCCH, the one or more dedicated random access resources are semi-statically configured. The one or more dedicated random access resources are activated when the network device sends the PDCCH to the terminal device.

In an optional implementation, the first indication information is carried in random access response information or downlink control information DCI.

In an optional implementation, the terminal device may further start a first timer when sending the BWP switching request by using the first random access resource. The terminal device performs radio resource control RRC reestablishment when the first timer expires and the first indication information is not received. This manner helps the terminal device recover communication in an RRC reestablishment manner when the terminal device does not obtain the standby BWP within preset time.

In an optional implementation, the terminal device may further monitor signal quality on the serving BWP, and switch from the first standby BWP to the serving BWP when the signal quality on the serving BWP is better than a first preset value. In this manner, when the signal quality of the serving BWP recovers, the terminal device can still perform communication by using the serving BWP, to improve communication quality.

In an optional implementation, when signal quality on the serving BWP is less than a second preset value, the terminal device determines that the serving BWP fails.

In an optional implementation, when the serving BWP fails and the terminal device determines that there is no candidate beam for beam recovery, the terminal device determines that beam recovery fails.

According to a second aspect, this application further provides a bandwidth part processing method. The bandwidth part processing method in this aspect corresponds to the bandwidth part processing method in the first aspect. The bandwidth part processing method in this aspect is described from a network device side (which may be applied to a device or a chip of the network device). In the method, when detecting a bandwidth part BWP switching request on a first random access resource, a network device determines a first standby BWP set from one or more standby BWP sets based on the first random access resource. A coverage enhancement level of a standby BWP in the first standby BWP set is higher than a coverage enhancement level of a serving BWP of a terminal device, and the first random access resource is any one of one or more dedicated random access resources. The network device sends first indication information, where the first indication information indicates a first standby BWP, and the first standby BWP is a standby BWP in the first standby BWP set.

In this embodiment of this application, the network device determines the first standby BWP set from the one or more standby BWP sets based on the first random access resource used by the terminal device to send the BWP switching request, and indicates the first standby BWP in the first standby BWP set to the terminal device. A coverage level of the first standby BWP is higher than a coverage level of the BWP serving the terminal device. Therefore, when the serving BWP fails or beam recovery fails, the terminal device switches from the serving BWP to the first standby BWP. This helps maintain communication continuity.

In an optional implementation, when signal quality on the serving BWP of the terminal device is poor, the network device sends a physical downlink control channel PDCCH, where the PDCCH is used to trigger the terminal device to send the BWP switching request by using a dedicated random access resource. This manner helps send, by using the dedicated random access resource, the BWP switching request to the network device when the signal quality on the serving BWP of the terminal device is poor, to request to switch the serving BWP, thereby helping maintain communication continuity.

In an optional implementation, the network device may further send configuration information, where the configuration information includes one or more standby BWP sets and a dedicated random access resource associated with each of the one or more standby BWP sets, and each of the standby BWP sets includes one or more standby BWPs.

The network device configures one or more standby BWP sets for the terminal device, so that when the serving BWP fails or beam recovery fails, the terminal device selects one standby BWP set from the one or more standby BWP sets to send the BWP switching request. The network device further configures, for the terminal device, the dedicated random access resource associated with each of the one or more standby BWP sets, so that the network device can determine, based on the dedicated random access resource occupied by the BWP switching request, the standby BWP set selected by the terminal device, and further determine, from the standby BWP set, a standby BWP to which the terminal device is to switch.

In an optional implementation, the one or more dedicated random access resources are semi-statically configured. In this manner, the one or more dedicated random access resources are activated when the network device sends the PDCCH.

In an optional implementation, the first indication information is carried in a random access response or downlink control information DCI.

According to a third aspect, this application further provides a bandwidth part processing method. The bandwidth part processing method in this aspect is described from a network device side (which may be applied to a device or a chip of the network device). In the method, a network device determines a second standby BWP when signal quality on a serving bandwidth part BWP of a terminal device is less than a third preset value. The network device sends second indication information, where the second indication information indicates the second standby BWP, and a coverage enhancement level of the second standby BWP is higher than a coverage enhancement level of the serving BWP.

In this embodiment of this application, when determining that signal quality on the serving BWP of the terminal device is poor, the network device indicates, to the terminal device, the second standby BWP whose coverage enhancement level is higher than the coverage enhancement level of the serving BWP. This helps the terminal device switch from the serving BWP to the second standby BWP when the serving BWP fails or beam recovery fails, thereby helping maintain communication continuity.

In an optional implementation, the second indication information is carried in downlink control information DCI.

According to a fourth aspect, an embodiment of this application further provides a bandwidth part processing method, and the method may be applied to a terminal device (for example, a device or a chip of the terminal device). The method includes: The terminal device receives second indication information, where the second indication information indicates a second standby bandwidth part BWP, and a coverage enhancement level of the second standby BWP is higher than a coverage enhancement level of a serving BWP of the terminal device. The terminal device activates the second standby BWP.

In this embodiment of this application, the terminal device obtains the second standby BWP whose coverage enhancement level is higher than the coverage enhancement level of the serving BWP, so that the terminal device activates the second standby BWP, and performs communication on the second standby BWP. This can maintain communication continuity.

In an optional implementation, the terminal device may further monitor the signal quality on the serving BWP, and switch from the second standby BWP to the serving BWP when the signal quality on the serving BWP is better than a first preset value. In this manner, when the signal quality of the serving BWP recovers, the terminal device can still perform communication by using the serving BWP, to improve communication quality.

In an optional implementation, the second indication information is carried in downlink control information DCI.

According to a fifth aspect, this application further provides a communication apparatus. The communication apparatus can implement some or all functions of the terminal device according to the first aspect, or implement some or all functions of the network device according to the second aspect, or implement some or all functions of the network device according to the third aspect, or implement some or all functions of the terminal device according to the fourth aspect. For example, functions of the communication apparatus may be functions in some or all of embodiments of the terminal device according to the first aspect of this application, or may be functions of independently implementing any embodiment of this application. The function may be implemented by hardware, or may be implemented by hardware executing corresponding software. The hardware or the software includes one or more units or modules corresponding to the functions.

In a possible design, a structure of the communication apparatus may include a processing unit and a communication unit. The processing unit is configured to support the communication apparatus in performing a corresponding function in the foregoing method. The communication unit is configured to support communication between the communication apparatus and another communication apparatus. The communication apparatus may further include a storage unit. The storage unit is coupled to the processing unit and the communication unit, and configured to store program instructions and data that are necessary for the communication apparatus.

In an implementation, the communication apparatus includes a processing unit and a communication unit, and the processing unit is configured to control the communication unit to perform data/signaling receiving and sending.

The communication unit is configured to send a bandwidth part BWP switching request by using a first random access resource.

The first random access resource is any one of one or more dedicated random access resources, the first random access resource is associated with a first standby BWP set, and a coverage enhancement level of a standby BWP in the first standby BWP set is higher than a coverage enhancement level of a serving BWP of a terminal device.

The communication unit is further configured to receive first indication information, where the first indication information indicates a first standby BWP, and the first standby BWP is a standby BWP in the first standby BWP set.

In addition, for another optional implementation of the communication apparatus in this aspect, refer to related content of the first aspect. Details are not described herein again.

In another implementation, the communication apparatus includes:
a processing unit, configured to: when a bandwidth part BWP switching request is detected on a first random access resource, determine a first standby BWP set from one or more standby BWP sets based on the first random access resource, where
a coverage enhancement level of a standby BWP in the first standby BWP set is higher than a coverage enhancement level of a serving BWP of a terminal device, and the first random access resource is any one of one or more dedicated random access resources; and
a communication unit, configured to send first indication information, where the first indication information indicates a first standby BWP, and the first standby BWP is a standby BWP in the first standby BWP set.

In addition, for another optional implementation of the communication apparatus in this aspect, refer to related content of the second aspect. Details are not described herein again.

In another implementation, the communication apparatus includes:
a processing unit, configured to determine a second standby BWP when signal quality on a serving bandwidth part BWP of a terminal device is less than a third preset value; and
a communication unit, configured to send second indication information, where the second indication information indicates a second standby BWP, and a coverage enhancement level of the second standby BWP is higher than a coverage enhancement level of the serving BWP.

In addition, for another optional implementation of the communication apparatus in this aspect, refer to related content of the third aspect. Details are not described herein again.

In another implementation, the communication apparatus includes:
a communication unit, configured to receive second indication information, where the second indication information indicates a second standby bandwidth part BWP, and a coverage enhancement level of the second standby BWP is higher than a coverage enhancement level of a serving BWP of a terminal device; and
a processing unit, configured to activate the second standby BWP.

In addition, for another optional implementation of the communication apparatus in this aspect, refer to related content of the fourth aspect. Details are not described herein again.

In an example, the communication unit may be a transceiver or a communication interface, the storage unit may be a memory, and the processing unit may be a processor.

In an implementation, the communication apparatus includes a processor and a transceiver. The processor is configured to control the transceiver to perform data/signaling receiving and sending.

The transceiver is configured to send a bandwidth part BWP switching request by using a first random access resource.

The first random access resource is any one of one or more dedicated random access resources, the first random access resource is associated with a first standby BWP set, and a coverage enhancement level of a standby BWP in the first standby BWP set is higher than a coverage enhancement level of a serving BWP of a terminal device.

The transceiver is further configured to receive first indication information, where the first indication information indicates a first standby BWP, and the first standby BWP is a standby BWP in the first standby BWP set.

In addition, for another optional implementation of the uplink communication apparatus in this aspect, refer to related content of the first aspect. Details are not described herein again.

In another implementation, the communication apparatus includes:
a processor, configured to: when a bandwidth part BWP switching request is detected on a first random access resource, determine a first standby BWP set from one or more standby BWP sets based on the first random access resource, where
a coverage enhancement level of a standby BWP in the first standby BWP set is higher than a coverage enhancement level of a serving BWP of a terminal device, and the first random access resource is any one of one or more dedicated random access resources; and
a transceiver, configured to send first indication information, where the first indication information indicates a first standby BWP, and the first standby BWP is a standby BWP in the first standby BWP set.

In addition, for another optional implementation of the uplink communication apparatus in this aspect, refer to related content of the second aspect. Details are not described herein again.

In another implementation, the communication apparatus includes:
a processor, configured to determine a second standby BWP when signal quality on a serving bandwidth part BWP of a terminal device is less than a third preset value; and
a transceiver, configured to send second indication information, where the second indication information indicates a second standby BWP, and a coverage enhancement level of the second standby BWP is higher than a coverage enhancement level of the serving BWP.

In addition, for another optional implementation of the uplink communication apparatus in this aspect, refer to related content of the third aspect. Details are not described herein again.

In another implementation, the communication apparatus includes:
a transceiver, configured to receive second indication information, where the second indication information indicates a second standby bandwidth part BWP, and a coverage enhancement level of the second standby BWP is higher than a coverage enhancement level of a serving BWP of a terminal device; and
a processor, configured to activate the second standby BWP.

In addition, for another optional implementation of the uplink communication apparatus in this aspect, refer to related content of the fourth aspect. Details are not described herein again.

In another implementation, the communication apparatus is a chip or a chip system. The processing unit may also be represented as a processing circuit or a logic circuit. The communication unit may be an input/output interface, an interface circuit, an output circuit, an input circuit, a pin, a related circuit, or the like on the chip or the chip system.

In an implementation process, the processor may be configured to perform, for example, but not limited to, baseband-related processing; and the transceiver may be configured to perform, for example, but not limited to, radio frequency receiving and sending. The foregoing components may be separately disposed on chips independent of each other, or at least some or all of the components may be disposed on a same chip. For example, the processor may be divided into an analog baseband processor and a digital baseband processor. The analog baseband processor and the transceiver may be integrated on a same chip, and the digital baseband processor may be disposed on an independent chip. With continuous development of an integrated circuit technology, more components may be integrated on a same chip. For example, the digital baseband processor and a plurality of application processors (for example, but not limited to, a graphics processing unit and a multimedia processor) may be integrated on a same chip. The chip may be referred to as a system-on-a-chip (SoC). Whether the components are independently disposed on different chips or are integrated and disposed on one or more chips usually depends on a requirement of product design. Implementation forms of the foregoing components are not limited in embodiments of this application.

According to a sixth aspect, this application further provides a processor, configured to perform the foregoing methods. In a process of performing these methods, a process of sending the foregoing information and a process of receiving the foregoing information in the foregoing methods may be understood as a process of outputting the foregoing information by the processor and a process of receiving the foregoing input information by the processor. When outputting the information, the processor outputs the information to a transceiver, so that the transceiver transmits the information. After the information is output by the processor, other processing may further need to be performed on the information before the information arrives at the transceiver. Similarly, during receiving of the input information by the processor, the transceiver receives the information, and inputs the information to the processor. Further, after the transceiver receives the foregoing information, other processing may further need to be performed on the information before processed information is input into the processor.

Unless otherwise specified, operations such as sending and receiving related to the processor may be more generally understood as operations such as output, receiving, and input of the processor if the operations do not conflict with actual functions or internal logic of the operations in related descriptions, instead of operations such as sending and receiving directly performed by a radio frequency circuit and an antenna.

In an implementation process, the processor may be a processor specially configured to perform these methods, or a processor, for example, a general-purpose processor, that executes computer instructions in the memory to perform these methods. The memory may be a non-transitory memory such as a read-only memory (ROM). The memory and the processor may be integrated on a same chip, or may be separately disposed on different chips. A type of the memory and a manner of disposing the memory and the processor are not limited in this embodiment of this application.

According to a seventh aspect, this application further provides a communication system. The system includes one or more network devices and one or more terminal devices. In another possible design, the system may further include another device that interacts with the network device and the terminal device.

According to an eighth aspect, this application provides a computer-readable storage medium, configured to store instructions. When the instructions are run by a computer, the method according to any one of the first aspect to the fourth aspect is implemented.

According to a ninth aspect, this application further provides a computer program product including instructions. When the computer program product runs on a computer, the method according to any one of the first aspect to the fourth aspect is implemented.

According to a tenth aspect, this application provides a chip system. The chip system includes a processor and an interface. The interface is configured to obtain a program or instructions. The processor is configured to invoke the program or the instructions to implement or support a terminal device in implementing the function in the first aspect, or implement or support a network device in implementing the function in the second aspect, or implement or support a network device in implementing the function in the third aspect, or implement or support a terminal device in implementing the function in the fourth aspect, for example, determining or processing at least one of data and information in the foregoing method. In a possible design, the chip system further includes a memory. The memory is configured to store program instructions and data that are necessary for a terminal. The chip system may include a chip, or may include a chip and another discrete component.

According to an eleventh aspect, this application provides a communication apparatus including a processor, configured to execute a computer program or executable instructions stored in a memory. When the computer program or the executable instructions are executed, the apparatus is enabled to perform the method according to any one of the possible implementations of the first aspect to the fourth aspect.

In a possible implementation, the processor and the memory are integrated together.

In another possible implementation, the memory is located outside the communication apparatus.

For beneficial effects of the fifth aspect to the eleventh aspect, refer to beneficial effects of the first aspect to the fourth aspect. Details are not described herein again.

### BRIEF DESCRIPTION OF DRAWINGS

FIG. 1 is a diagram of a system structure of a communication system according to an embodiment of this application;

FIG. 2 is a distribution diagram of a bandwidth part according to an embodiment of this application;

FIG. 3 is another distribution diagram of a bandwidth part according to an embodiment of this application;

FIG. 4 is still another distribution diagram of a bandwidth part according to an embodiment of this application;

FIG. 5 is a diagram of communication between a terminal device and a base station according to an embodiment of this application;

FIG. 6 is an interaction diagram of a bandwidth part processing method according to an embodiment of this application;

FIG. 7 is a schematic flowchart of interaction between a terminal device and a network device according to an embodiment of this application;

FIG. 8 is an interaction diagram of another bandwidth part processing method according to an embodiment of this application;

FIG. 9 is a diagram of a structure of a communication apparatus according to an embodiment of this application; and

FIG. 10 is a diagram of a structure of another communication apparatus according to an embodiment of this application.

### DESCRIPTION OF EMBODIMENTS

The following clearly describes the technical solutions in embodiments of this application with reference to the accompanying drawings in embodiments of this application.

The terms “first”, “second”, and the like in this specification, the claims, and the accompanying drawings of this application are intended to distinguish between different objects, but not to describe a specific sequence. “First” and “second” are merely intended for description, and shall not be understood as an indication or implication of relative importance or implicit indication of a quantity of indicated technical features. Therefore, a feature limited by “first” or “second” may explicitly or implicitly include one or more such features. In the description of embodiments, unless otherwise specified, “a plurality of” means two or more.

In addition, the terms “including”, “having”, and any other variant thereof are intended to cover non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

It should be understood that, in this application, “a plurality of” means two or more. “And/or” describes an association relationship between associated objects, and indicates that three relationships may exist. For example, “A and/or B” may represent three cases: Only A exists, only B exists, and both A and B exist, where A and B may be singular or plural. The character “/” usually indicates an “or” relationship between the associated objects. Both “when” and “if” mean that corresponding processing is performed in an objective case, but are not intended to limit time. In addition, the terms do not necessarily mean that a determining action is performed during implementation, and do not mean another limitation either.

In embodiments of this application, the word such as “example” or “for example” is used to represent giving an example, an illustration, or a description. Any embodiment or design scheme described as the word “example” or “for example” in embodiments of this application should not be explained as being more preferred or having more advantages than another embodiment or design scheme. Exactly, use of the terms such as “example” or “for example” is intended to present a related concept in a specific manner for ease of understanding.

### I. Communication System

To better understand a bandwidth part processing method disclosed in embodiments of this application, a communication system applicable to embodiments of this application is described.

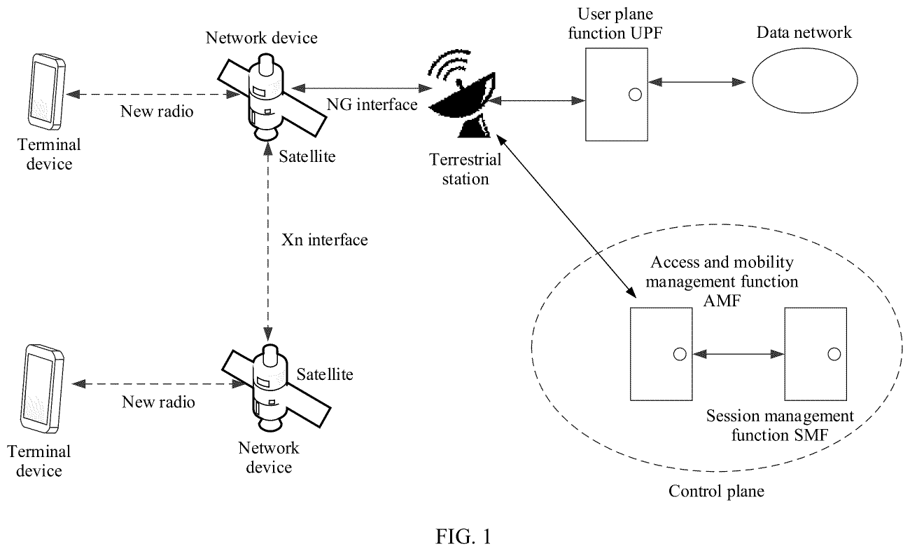

Embodiments of this application may be applied to satellite communication, and a system architecture is shown in FIG. 1. As shown in FIG. 1, a terrestrial mobile terminal device accesses, through a new air interface, a network device deployed on a satellite. The network device deployed on the satellite is connected to a terrestrial core network through a terrestrial station, and the network device deployed on the satellite is connected to the terrestrial station through an interface (for example, an NG interface). The core network includes a user plane function (user plane function, UPF) and a control plane. The control plane includes an access and mobility management function (AMF) and a session management function (SMF). In addition, network devices (for example, 5th generation mobile communication (5G) base stations) deployed on satellites may be connected to each other through an interface (for example, an Xn interface), to complete signaling exchange between the network devices.

The terminal device in embodiments of this application may include various devices with a wireless communication function, for example, a handheld device, a vehicle-mounted device, a wearable device, a computing device, or another processing device connected to a wireless modem. The terminal device may also be referred to as a terminal. The terminal device may also be user equipment (UE), an access terminal, a subscriber unit, a user agent, a cellular phone, a smartphone, a wireless data card, a personal digital assistant (PDA) computer, a tablet computer, a wireless modem, a handheld device (handset), a laptop computer, a machine type communication (MTC) terminal, a communication device mounted on a high-altitude aircraft, a wearable device, an uncrewed aerial vehicle, a robot, a terminal in device-to-device (D2D) communication, a terminal in vehicle-to-everything (V2X), a virtual reality (VR) terminal device, an augmented reality (AR) terminal device, a wireless terminal in industrial control, a wireless terminal in self-driving, a wireless terminal in remote medical, a wireless terminal in a smart grid, a wireless terminal in transportation safety, a wireless terminal in a smart city, a wireless terminal in a smart home, a terminal device in a future communication network, or the like. This is not limited in this application.

The network device in embodiments of this application is a device with a wireless transceiver function and is configured to communicate with the terminal device. The network device may be an evolved NodeB (eNB or eNodeB) in LTE, a base station in a 5G/6th generation mobile communication (6G) network, a base station in a future evolved public land mobile network (PLMN), a broadband network gateway (BNG), an aggregation switch, a non-3rd generation partnership project (3GPP) access device, or the like. Optionally, the network device in embodiments of this application may include base stations in various forms, for example, a macro base station, a micro base station (also referred to as a small cell), a relay station, an access point, a device for implementing a base station function in the future, an access node in a wireless fidelity (Wi-Fi) system, a transmitting and receiving point (TRP), a transmitting point (TP), a mobile switching center, and a device that provides a base station function in device-to-device (D2D), vehicle-to-everything (V2X), or machine-to-machine (M2M) communication. This is not specifically limited in embodiments of this application.

The core network (CN) can implement services such as user access control, mobility management, user security authentication, and charging. The core network includes a plurality of functional units, which may be classified into a control plane functional entity and a data plane functional entity. An access and mobility management AMF responsible for user access management, security authentication, and mobility management. A user plane function UPF is responsible for managing functions such as user plane data transmission and traffic statistics collection.

A terrestrial station is responsible for forwarding signaling and service data between a satellite base station and the core network.

An Xn interface is an interface between 5G base stations, and is mainly used for exchanging signaling, for example, handover.

An NG interface is an interface between a 5G base station and a 5G core network, and is mainly used for exchanging signaling such as network attached storage (NAS) signaling of the core network and service data of a user.

The terminal device in embodiments of this application may access a satellite network through an air interface, and initiate services such as a call and internet access to the satellite network. The network device in embodiments of this application may be deployed on a satellite.

### II. Related Concepts

To better understand a bandwidth part processing method disclosed in embodiments of this application, related concepts in embodiments of this application are briefly described.

### 1. Bandwidth Part (BWP)

The bandwidth part BWP is a segment of contiguous frequency domain resources, and the bandwidth part may also be referred to as a carrier bandwidth part, namely, a carrier BWP. In new radio (NR), for a serving cell, a base station may configure a maximum of four BWPs for one UE. For one UE, one BWP can be activated, and the UE sends and receives data on the active BWP.

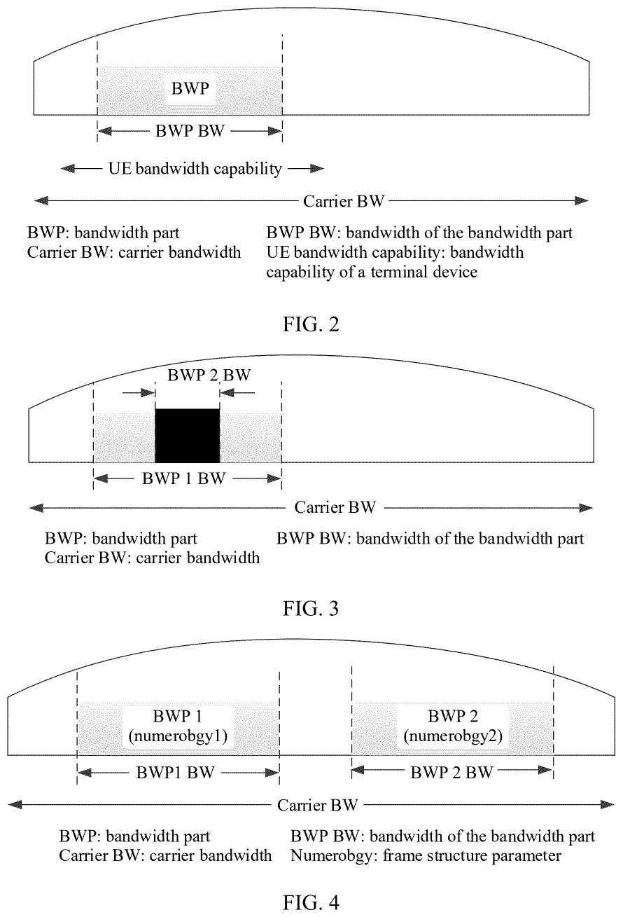

As shown in FIG. 2, a BWP bandwidth (BWP BW) is less than or equal to a bandwidth supported by a bandwidth capability (UE bandwidth capability) of the UE. The bandwidth supported by the bandwidth capability of the UE is less than or equal to a carrier bandwidth (BW). In other words, the BWP is a segment of bandwidth in a carrier.

When the base station configures BWPs for the UE, different bandwidths may be configured for different BWPs. In addition, frequency domain resources of two BWPs may overlap. For example, as shown in FIG. 3, bandwidths of a BWP 1 and a BWP 2 are different, and the BWP 1 and the BWP 2 overlap on a frequency domain resource.

In addition, when configuring the BWPs for the UE, the base station may indicate a frame structure parameter (numerology) for each BWP. A frame structure parameter may include a subcarrier spacing and/or a cyclic prefix (CP) length. For example, as shown in FIG. 4, when the base station configures a BWP 1 for the UE, it indicates that a numerology of the BWP 1 is a numerology 1; and when the base station configures a BWP 2 for the UE, it indicates that a numerology of the BWP 2 is a numerology 2.

### 2. Carrier Aggregation (CA)

Carrier aggregation CA is to aggregate two or more component carriers (CCs) to support a larger transmission bandwidth. For example, as shown in FIG. 5, a base station configures three carriers for UE, and the three carriers include a primary carrier (PCC), and a secondary carrier (SCC) 1 and an SCC 2. A cell corresponding to the PCC is referred to as a primary cell (PCell), and a cell corresponding to a secondary carrier SCC is referred to as a secondary cell (SCell). The UE performs radio resource control (RRC) connection with the PCell by using the PCC.

The base station may configure an SCell for the UE by using an RRC message, and activate the SCell when the SCell meets a specific condition. Generally, a newly configured SCell is in an inactive state, and the base station needs to determine, based on a service requirement, whether to activate the SCell.

In embodiments disclosed in this application, all aspects, embodiments, or features of this application are presented by describing a system including a plurality of devices, components, modules, and the like. It should be appreciated and understood that, each system may include another device, component, module, and the like, and/or may not include all devices, components, modules, and the like discussed with reference to the accompanying drawings. In addition, a combination of these solutions may be used.

In a cellular network, a base station configures beam failure recovery (BFR) configuration information for a terminal device based on a capability reported by the terminal device. The BFR configuration information includes information such as a beam detection set, a beam recovery candidate set, and a physical random access channel (PRACH) resource.

The terminal device performs beam detection on a beam in the beam detection set. If a quantity of beam failures reported by a physical layer of the terminal device is greater than or equal to a beam failure instance maximum count during timing of a beam failure detection timer, it is determined that the beam fails.

After the beam fails, the terminal device selects an appropriate beam from the beam recovery candidate set, and initiates a random access request, that is, sends a beam failure recovery request. The random access request carries information about the selected beam. There is an association relationship between the random access request initiated by the terminal device and the selected beam, so that a network device may determine, based on the received random access request, the beam selected by the terminal device from the candidate beam set. Further, the network device sends a beam failure recovery response for the beam to the terminal device.

The terminal device monitors the random access response on the selected beam, and switches to the selected beam if the random access response is detected, to recover communication on the selected beam.

For a non-terrestrial network (NTN) scenario, the terminal device cannot be covered by a plurality of beams in most cases. Consequently, when the current serving beam fails, the terminal device cannot perform beam recovery by selecting a candidate beam. As a result, communication interruption such as network disconnection is caused.

### III. Bandwidth Part Processing Method 100

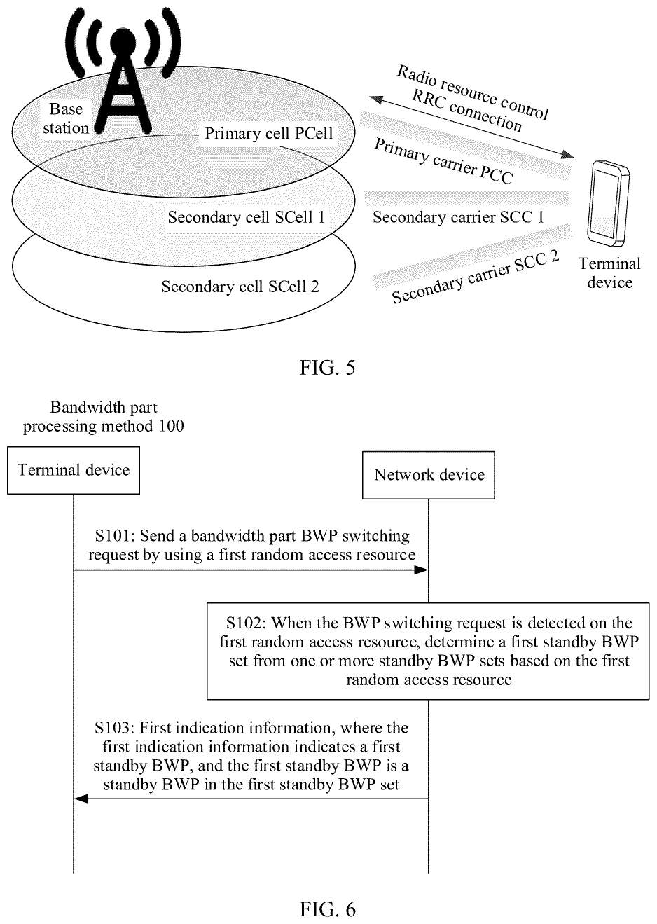

An embodiment of this application provides a bandwidth part processing method 100. FIG. 6 is an interaction diagram of the bandwidth part processing method 100. The bandwidth part processing method 100 is described from the perspective of interaction between a terminal device and a network device. The bandwidth part processing method 100 includes but is not limited to the following steps.

S101: The terminal device sends a bandwidth part BWP switching request by using a first random access resource. Correspondingly, the network device monitors the BWP switching request.

The first random access resource is any one of one or more dedicated random access resources, and the BWP switching request is used to request to switch a serving BWP.

The one or more dedicated random access resources are preconfigured by the network device for the terminal device, and are random access resources used by the terminal device to send the BWP switching request when the BWP fails or beam recovery fails. Therefore, the terminal device may further receive configuration information, where the configuration information includes one or more standby BWP sets and a dedicated random access resource associated with each of the one or more standby BWP sets, and each of the standby BWP sets includes one or more standby BWPs. Correspondingly, the network device sends the configuration information.

In other words, the network device configures the one or more standby BWP sets and the one or more dedicated random access resources for the terminal device by using the configuration information, and each of the one or more standby BWP sets has an association relationship with each of the one or more dedicated random access resources. The association relationship may also be a mapping relationship. To be specific, the network device establishes a mapping relationship between each of the one or more standby BWP sets and each of the one or more dedicated random access resources, and each standby BWP corresponds to one dedicated random access resource.

Before initiating the BWP switching request, the terminal device selects a standby BWP set from the one or more standby BWP sets, to send the BWP switching request by using a dedicated random access resource corresponding to the selected standby BWP set, so as to request to switch a serving BWP.

The first random access resource is associated with a first standby BWP set. Therefore, when the terminal device sends the BWP switching request by using the first random access resource, it may indicate that the standby BWP set selected by the terminal device from the one or more standby BWP sets is the first standby BWP set, so that the network device can determine, from the first standby BWP set, a standby BWP to which the terminal device is to switch.

A coverage enhancement level of a standby BWP in the first standby BWP set is higher than a coverage enhancement level of the serving BWP of the terminal device, so that when the serving BWP fails or beam recovery fails, the terminal device switches from the serving BWP to a standby BWP whose coverage enhancement level is higher than that of the serving BWP. This helps maintain communication continuity.

It may be understood that, for each of the one or more standby BWP sets, a coverage enhancement level of each of one or more standby BWPs in the standby BWP set is higher than the coverage enhancement level of the serving BWP. This manner helps the terminal device switch to a standby BWP whose coverage enhancement level is higher than that of the serving BWP when the serving BWP fails or beam recovery fails.

That the coverage enhancement level of the standby BWP is higher than the coverage enhancement level of the serving BWP may also be understood as that signal quality in communication performed by using the standby BWP is better than signal quality in communication performed by using the serving BWP. In this manner, when signal quality of the terminal device on the serving BWP is poor, for example, when the serving BWP fails or beam recovery fails, the terminal device may switch to a standby BWP whose coverage enhancement level is higher than that of the serving BWP, to maintain communication continuity.

In an optional implementation, the network device configures a subcarrier spacing of the standby BWP to be less than a subcarrier spacing of the serving BWP, so that the coverage enhancement level of the standby BWP is higher than the subcarrier spacing of the serving BWP.

In another optional implementation, the network device configures a quantity of repetition times of transmitting a signal and/or channel by the terminal device on the standby BWP to be greater than a quantity of repetition times of transmitting a signal and/or channel on the serving BWP, so that the coverage enhancement level of the standby BWP is higher than the coverage enhancement level of the serving BWP. For example, the network device configures a quantity of repetition times of transmitting a physical random access channel (PRACH), a physical downlink shared channel (PDSCH), or a physical uplink shared channel (PUSCH) by the terminal device on the standby BWP to be greater than a quantity of repetition times of transmitting these channels on the serving BWP.

In still another optional implementation, the network device configures a higher aggregation level for a physical downlink control channel (PDCCH), so that more physical resources can be aggregated together for use by the PDCCH. In this way, a decoding threshold of the terminal device can be reduced, and the coverage enhancement level of the standby BWP can be increased, so that the coverage enhancement level of the standby BWP is higher than the coverage enhancement level of the serving BWP.

In yet another optional implementation, the network device configures a length of a preamble sequence used when the terminal device performs random access by using the standby BWP to be greater than a length of a preamble sequence used when the terminal device performs random access by using the serving BWP, so that the coverage enhancement level of the standby BWP is higher than the coverage enhancement level of the serving BWP.

It may be understood that an implementation in which the network device configures the coverage enhancement level of the standby BWP to be higher than the coverage enhancement level of the serving BWP of the terminal device includes but is not limited to the foregoing implementations.

It may be understood that the serving BWP of the terminal device may also be understood as an active BWP of the terminal device, namely, Active_BWP.

It may be understood that performance of standby BWPs in each standby BWP set is different. For example, different standby BWPs have different coverage levels, different data throughputs, and the like. Performance of each standby BWP may be determined by the network device in a capability negotiation process with the terminal device, and then configured by the network device for the terminal.

In an optional implementation, the network device may configure BWP_switch_config for the terminal device in a radio resource control (RRC) configuration (reconfiguration). The BWP_switch_config carries additional prach-Configuration Index, and prach-Configuration Index indicates one or more dedicated random access resources.

In an optional implementation, when determining that the serving BWP fails, the terminal device sends the BWP switching request by using the first random access resource. When the serving BWP of the terminal device fails, it indicates that a serving beam of the terminal device fails, the terminal device cannot continue to perform communication by using the serving BWP corresponding to the serving beam, and there is a risk of communication interruption like a call drop or a network disconnection. Therefore, the terminal device needs to send the BWP switching request, to request to switch the serving BWP. This helps recover communication and maintains communication continuity.

It may be understood that when the signal quality on the serving BWP is less than a second preset value, the terminal device determines that the serving BWP fails. The second preset value may be preconfigured by the network device, or may be determined by the terminal device in advance. In other words, when the signal quality is poor when the terminal device transmits a signal and/or channel by using the serving BWP, it indicates that the serving BWP fails.

In another optional implementation, when determining that beam recovery fails, the terminal device sends the BWP switching request by using the first random access resource.

That beam recovery fails means that when a serving beam fails or the serving BWP fails, the terminal device selects a candidate beam from a candidate beam set to perform beam recovery, and if there is no candidate beam for selection by the terminal device, determines that beam recovery fails.

When the terminal device fails to perform beam recovery, the terminal device cannot continue to perform communication by using the serving BWP corresponding to the serving beam. Therefore, the terminal device also needs to request to switch the serving BWP.

In still another optional implementation, when receiving the physical downlink control channel PDCCH, the terminal device sends the BWP switching request by using the first random access resource. The PDCCH is used to trigger the terminal device to send the BWP switching request by using the dedicated random access resource. Correspondingly, when determining that the signal quality on the serving BWP of the terminal device is poor, the network device sends the PDCCH, to trigger the terminal device to send the BWP switching request by using the dedicated random access resource.

In this manner, the network device may determine the signal quality on the serving BWP of the terminal device based on uplink measurement or a statistical amount fed back by another terminal device in a service area. A parameter measured by the network device may be each uplink signal and/or channel sent by the terminal device, for example, a preamble, a sounding reference signal (SRS), a demodulated reference signal (DMRS), a channel quality indicator (CQI), or a PUSCH.

It may be understood that BWP request information may be carried in a random access request. In other words, the terminal device initiates the random access request to the network device by using the first random access resource, where the random access request carries the BWP request information, so that the network device obtains the BWP switching request.

S102: When detecting the BWP switching request on the first random access resource, the network device determines the first standby BWP set from the one or more standby BWP sets based on the first random access resource.

When detecting the BWP switching request on the first random access resource, the network device determines that the terminal device needs to switch the serving BWP, to determine the first standby BWP set from the one or more standby BWP sets based on the first random access resource.

In an optional implementation, when configuring the one or more standby BWP sets for the terminal device, the network device associates each standby BWP set with one dedicated random access resource, that is, establishes a mapping relationship between each standby BWP set and one dedicated random access resource. Therefore, the network device determines, based on the first random access resource and the association relationship between the standby BWP set and the dedicated random access resource, the first standby BWP set selected when the terminal device sends the BWP switching request, activates the first standby BWP set selected by the terminal device, and determines, from the active standby BWP set, the standby BWP to which the terminal device needs to switch.

For example, the standby BWP set configured by the network device for the terminal device includes a standby BWP set 1, a standby BWP set 2, and a standby BWP set 3. The standby BWP set 1 is associated with a dedicated random access resource a, the standby BWP set 2 is associated with a dedicated random access resource b, and the standby BWP set 3 is associated with a dedicated random access resource c. If the terminal device sends the BWP switching request by using the dedicated random access resource b, and the network device detects the BWP switching request on the dedicated random access resource b, the network device determines that the standby BWP set selected by the terminal device is the standby BWP set 2, that is, the first standby BWP set is the standby BWP set 2. Therefore, the network device activates the standby BWP set 2, and determines, from the standby BWP set, the standby BWP to which the terminal device needs to switch.

In another optional implementation, when the terminal device sends the BWP switching request by using the first random access resource, the first random access resource directly indicates the first standby BWP set. Therefore, the network device directly determines, based on the first random access resource, that the standby BWP set selected by the terminal device is the first standby BWP set.

S103: The network device sends first indication information, where the first indication information indicates a first standby BWP, and the first standby BWP is a standby BWP in the first standby BWP set. Correspondingly, the terminal device receives the first indication information.

It may be understood that after activating the first standby BWP set, the network device determines, based on a load status of each standby BWP in the first standby BWP set, the standby BWP to which the terminal device needs to switch. The standby BWP is referred to as a first standby BWP. Then, the network device indicates the first standby BWP to the terminal device by using the first indication information, so that the terminal device obtains the first standby BWP to which the terminal device is to switch.

For example, the standby BWP set 2 includes a standby BWP 1 and a standby BWP 2. The network device determines that load of the standby BWP 2 is low, and therefore determines that the standby BWP 2 is a BWP to which the terminal device needs to switch, that is, determines that the first standby BWP is the standby BWP 2.

In an optional implementation, the first indication information is carried in random access response information. In this manner, the network device sends the random access response information to the terminal device, and the terminal device receives the random access response information, and obtains the first indication information from the random access response information, to obtain the first standby BWP.

In another optional implementation, the first indication information is carried in downlink control information (DCI). In this manner, the network device sends the DCI to the terminal device, where an indication field of the DCI indicates the first standby BWP.

Optionally, the network device and the terminal device associate the indication field in the DCI with different standby BWPs in different standby BWP sets in advance, so that when receiving the DCI, the terminal device may determine, based on an indication status of the indication field in the DCI, a standby BWP indicated by the network device. This manner helps reduce signaling overheads between the network device and the terminal device.

In an optional implementation, the terminal device may further activate the first standby BWP, and perform communication on the first standby BWP, to recover communication and maintain communication continuity.

In an optional implementation, the terminal device starts a first timer when sending the BWP switching request by using the first random access resource. Duration of the first timer is predefined. When the first timer expires and the terminal device does not receive the first indication information, the terminal device determines that BWP recovery fails, and performs radio resource control (RRC) reestablishment, to attempt to recover communication in an RRC reestablishment manner.

In an optional implementation, the terminal device may further monitor the signal quality on the serving BWP, and switch from the first standby BWP to the serving BWP when the signal quality on the serving BWP is better than a first preset value. In other words, when detecting that the signal quality on the serving BWP recovers, the terminal device still performs communication by using the serving BWP, to improve communication quality.

It may be understood that, that the signal quality on the serving BWP is better than a first preset value means that when the terminal device transmits a signal and/or channel on the serving BWP, signal quality of the transmitted signal and/or channel is better than the first preset value. In addition, the signal quality on the serving BWP may be represented by a parameter like signal strength, a signal-to-noise ratio, and signal power. When the signal quality on the serving BWP is represented by any one of the signal strength, the signal-to-noise ratio, and the signal power, that the signal quality on the serving BWP is better than a first preset value means that signal strength, a signal-to-noise ratio, or signal power on the serving BWP is greater than the first preset value.

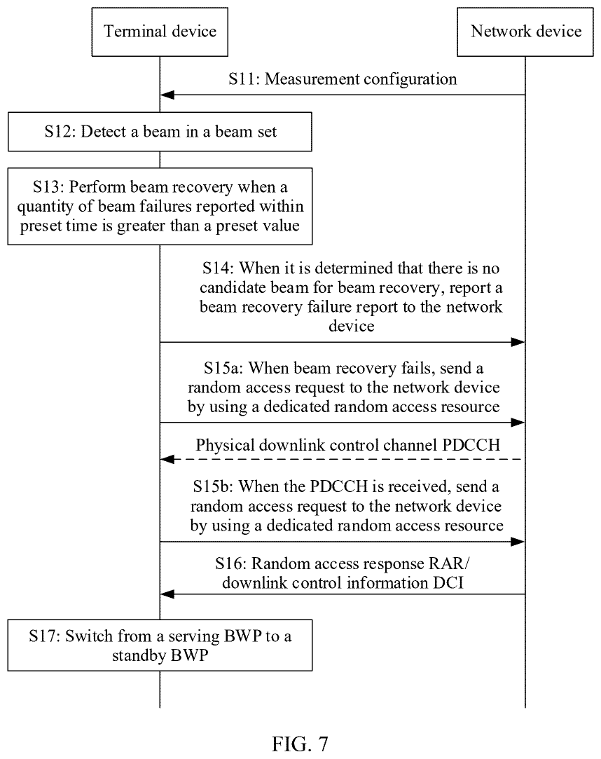

For example, FIG. 7 is an interaction diagram of communication between a terminal device and a network device. As shown in FIG. 7, a procedure of interaction between the terminal device and the network device includes but is not limited to the following steps: S11: The network device sends a measurement configuration to the terminal device. The measurement configuration includes a beam detection set, and the beam detection beam set includes one or more beams. Correspondingly, the terminal device receives the measurement configuration. S12: The terminal device performs beam detection on a beam in the detection beam set. S13: The terminal device performs beam recovery when a quantity of beam failures reported within preset time is greater than a preset value. S14: When determining that there is no candidate beam for beam recovery, the terminal device reports a beam recovery failure report to the network device. S15a: When beam recovery fails, the terminal device sends a random access request to the network device by using a dedicated random access resource. S15b: The network device sends a PDCCH to the terminal device, where the PDCCH is used to trigger the terminal device to send a BWP switching request. When receiving the PDCCH, the terminal device sends a random access request to the network device by using the dedicated random access resource. S16: The network device sends DCI or a random access response to the terminal device, where the DCI or the random access response carries a standby BWP. A coverage enhancement level of the standby BWP is higher than a coverage enhancement level of a serving BWP. S17: The terminal device switches from the serving BWP to the standby BWP. In this way, the terminal device performs communication on the standby BWP, and communication connection can be recovered.

S11 to S14 may be considered as a phase in which the terminal device detects a beam failure and performs beam recovery, and S15a, S15b, S16, and S17 may be considered as a phase in which the terminal device triggers BWP switching and switches to the standby BWP.

In this embodiment of this application, the terminal device sends the BWP switching request by using the dedicated random access resource. The network device determines, based on the dedicated random access resource used by the terminal device, a first standby BWP set selected by the terminal device. The network device selects, from the first standby BWP set, a first standby BWP to which the terminal device is to switch, and indicates the first standby BWP to the terminal device. A coverage enhancement level of the first standby BWP is higher than the coverage enhancement level of the serving BWP, so that the terminal device can switch from the serving BWP to the first standby BWP with a higher coverage enhancement level when the serving BWP fails or beam recovery fails. This helps maintain communication continuity and improve beam robustness.

### IV. Bandwidth Part Processing Method 200

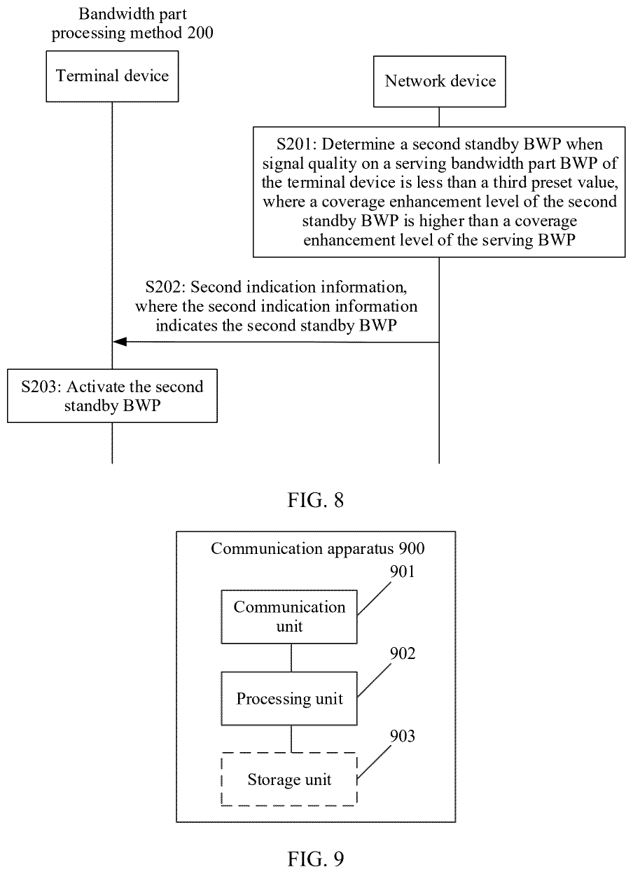

An embodiment of this application further provides a bandwidth part processing method 200. FIG. 8 is an interaction diagram of the bandwidth part processing method 200. The bandwidth part processing method 200 is also described from the perspective of interaction between a terminal device and a network device. The bandwidth part processing method includes but is not limited to the following steps.

S201: When signal quality on a serving bandwidth part BWP of the terminal device is less than a third preset value, the network device determines a second standby BWP, where a coverage enhancement level of the second standby BWP is higher than a coverage enhancement level of the serving BWP.

The third preset value is predefined by the network device.

When the signal quality on the serving BWP of the terminal device is less than the third preset value, it indicates that the signal quality on the serving BWP is poor, and the terminal device may be disconnected from a network. Therefore, the terminal device needs to switch the serving BWP. Therefore, the network device determines a second standby BWP whose coverage enhancement level is higher than the coverage enhancement level of the serving BWP, so that the terminal device can switch from the serving BWP to the second standby BWP when the signal quality on the serving BWP is poor, to maintain communication continuity.

In an optional implementation, the network device may further preconfigure one or more standby BWP sets for the terminal device. Each of the one or more standby BWP sets includes one or more standby BWPs, and a coverage enhancement level of each standby BWP is higher than the coverage enhancement level of the serving BWP of the terminal device. Therefore, when the signal quality on the serving BWP of the terminal device is poor, the network device determines, based on a load status of each standby BWP in the one or more standby BWP sets, the second standby BWP to which the terminal device is to switch.

For an implementation in which the network device configures the coverage enhancement level of the standby BWP to be higher than the coverage enhancement level of the serving BWP, refer to the implementations in the bandwidth part BWP processing method 100. Details are not described again.

S202: The network device sends second indication information, where the second indication information indicates the second standby BWP. Correspondingly, the terminal device receives the second indication information.

In an optional implementation, the second indication information is carried in downlink control information DCI, and the network device indicates the second standby BWP by using an indication field in the DCI.

S203: The terminal device activates the second standby BWP.

The terminal device activates the standby BWP, and performs communication on the standby BWP, to maintain communication continuity.

In an optional implementation, the terminal device may further monitor the signal quality on the serving BWP, and switch from the first standby BWP to the serving BWP when the signal quality on the serving BWP is better than a first preset value. In other words, when detecting that the signal quality on the serving BWP recovers, the terminal device still performs communication by using the serving BWP, to improve communication quality.

In this embodiment of this application, when the signal quality on the serving BWP of the terminal device is poor, the network device indicates, to the terminal device, the second standby BWP whose coverage enhancement level is higher than that of the serving BWP. Therefore, the terminal device activates the second standby BWP, and performs communication on the second standby BWP, so that communication interruption caused by poor signal quality on the serving BWP can be avoided. Therefore, communication continuity can be maintained, and beam robustness can be improved.

### V. Communication Apparatus

For the technical solution described above, the following further describes a corresponding apparatus implementation solution.

To implement functions in the method provided in the foregoing embodiments of this application, the terminal device and the network device may include a hardware structure and/or a software module, and the foregoing functions are implemented in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

As shown in FIG. 9, an embodiment of this application provides a communication apparatus 900. A communication apparatus 900 may be a component (for example, an integrated circuit or a chip) of a terminal device, or may be a component (for example, an integrated circuit or a chip) of a network device. Alternatively, the communication apparatus 900 may be another communication unit, configured to implement the method in the method embodiment of this application. The communication apparatus 900 may include a communication unit 901 and a processing unit 902. Optionally, the communication apparatus 900 may further include a storage unit 903.

In a possible design, one or more units in FIG. 9 may be implemented by one or more processors, implemented by one or more processors and memories, implemented by one or more processors and transceivers, or implemented by one or more processors, memories, and transceivers. This is not limited in this embodiment of this application. The processor, the memory, and the transceiver may be disposed separately, or may be integrated.

The communication apparatus 900 has a function of implementing a transmit end or a receive end described in embodiments of this application. For example, the communication apparatus 900 includes a corresponding module, unit, or means used for the transmit end to perform the steps related to the transmit end described in embodiments of this application. The function, the unit, or the means may be implemented by software or hardware, may be implemented by hardware executing corresponding software, or may be implemented by a combination of software and hardware. For details, refer to the corresponding descriptions in the foregoing corresponding method embodiment.

In a possible design, the communication apparatus 900 may include a communication unit 901 and a processing unit 902. The processing unit 902 is configured to control the communication unit 901 to receive and send data/signaling.

The communication unit 901 is configured to send a bandwidth part BWP switching request by using a first random access resource.

The first random access resource is any one of one or more dedicated random access resources, the first random access resource is associated with a first standby BWP set, and a coverage enhancement level of a standby BWP in the first standby BWP set is higher than a coverage enhancement level of a serving BWP of a terminal device.

The communication unit 901 is further configured to receive first indication information, where the first indication information indicates a first standby BWP, and the first standby BWP is a standby BWP in the first standby BWP set.

In an optional implementation, the processing unit 902 is configured to: when it is determined that the serving BWP fails or beam recovery fails, send the bandwidth part BWP switching request by using the first random access resource; or when the communication unit 901 receives a physical downlink control channel PDCCH, send the bandwidth part BWP switching request by using the first random access resource, where the PDCCH is used to trigger the terminal device to send the BWP switching request by using a dedicated random access resource.

In an optional implementation, the communication unit 901 is further configured to receive configuration information, where the configuration information includes one or more standby BWP sets and a dedicated random access resource associated with each of the one or more standby BWP sets, and each of the standby BWP sets includes one or more standby BWPs.

In an optional implementation, the one or more dedicated random access resources are semi-statically configured.

In an optional implementation, the first indication information is carried in a random access response or downlink control information DCI.

In an optional implementation, the processing unit 902 is further configured to: start a first timer when the communication unit 901 sends the BWP switching request by using the first random access resource; and perform radio resource control RRC reestablishment when the first timer expires and the first indication information is not received.

In an optional implementation, the processing unit 902 is further configured to: monitor signal quality on the serving BWP; and switch from the first standby BWP to the serving BWP when the signal quality on the serving BWP is better than a first preset value.

In an optional implementation, when the signal quality on the serving BWP is less than a second preset value, the processing unit 902 determines that the serving BWP fails.

In an optional implementation, when the serving BWP fails and it is determined that there is no candidate beam for beam recovery, it is determined that the beam recovery fails.

This embodiment of this application and the foregoing method embodiment are based on a same concept, and bring same technical effect. For a specific principle, refer to the descriptions of the foregoing embodiment. Details are not described again.

In another possible design, the communication apparatus 900 may include a processing unit 902 and a communication unit 901.

The processing unit 902 is configured to: when a bandwidth part BWP switching request is detected on a first random access resource, determine a first standby BWP set from one or more standby BWP sets based on the first random access resource.

A coverage enhancement level of a standby BWP in the first standby BWP set is higher than a coverage enhancement level of a serving BWP of a terminal device, and the first random access resource is any one of one or more dedicated random access resources.

The communication unit 901 is configured to send first indication information, where the first indication information indicates a first standby BWP, and the first standby BWP is a standby BWP in the first standby BWP set.

In an optional implementation, the communication unit 901 is further configured to send a physical downlink control channel PDCCH, where the PDCCH is used to trigger the terminal device to send the BWP switching request by using a dedicated random access resource.

In an optional implementation, the communication unit 901 is further configured to send configuration information, where the configuration information includes one or more standby BWP sets and a dedicated random access resource associated with each of the one or more standby BWP sets, and each of the standby BWP sets includes one or more standby BWPs.

In an optional implementation, the one or more dedicated random access resources are semi-statically configured.

In an optional implementation, the first indication information is carried in a random access response or downlink control information DCI.

This embodiment of this application and the foregoing method embodiment are based on a same concept, and bring same technical effect. For a specific principle, refer to the descriptions of the foregoing embodiment. Details are not described again.

In still another possible design, the communication apparatus 900 may include a processing unit 902 and a communication unit 901.

The processing unit 902 is configured to determine a second standby BWP when signal quality on a serving bandwidth part BWP of a terminal device is less than a third preset value.

The communication unit 901 is further configured to send second indication information, where the second indication information indicates a second standby BWP, and a coverage enhancement level of the second standby BWP is higher than a coverage enhancement level of the serving BWP.

In an optional implementation, the second indication information is carried in downlink control information DCI.

This embodiment of this application and the foregoing method embodiment are based on a same concept, and bring same technical effect. For a specific principle, refer to the descriptions of the foregoing embodiment. Details are not described again.

In yet another possible design, the communication apparatus 900 may include a processing unit 902 and a communication unit 901.

The communication unit 901 is configured to receive second indication information, where the second indication information indicates a second spare bandwidth part BWP, and a coverage enhancement level of the second standby BWP is higher than a coverage enhancement level of a serving BWP of a terminal device.

The processing unit 902 is configured to activate the second standby BWP for the terminal device.

In an optional implementation, the processing unit 902 is further configured to: monitor signal quality on the serving BWP, and switch from the second standby BWP to the serving BWP when the signal quality on the serving BWP is better than a first preset value.

In an optional implementation, the second indication information is carried in downlink control information DCI.

This embodiment of this application and the foregoing method embodiment are based on a same concept, and bring same technical effect. For a specific principle, refer to the descriptions of the foregoing embodiment. Details are not described again.

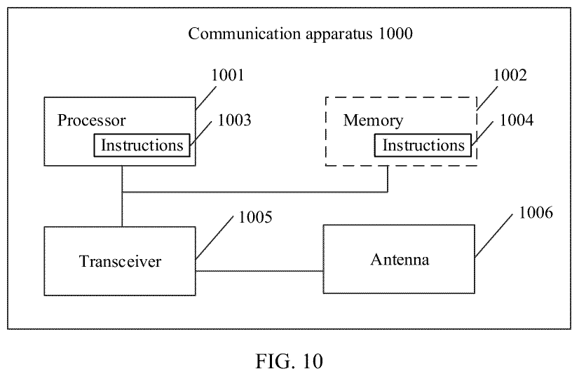

An embodiment of this application further provides a communication apparatus 1000. FIG. 10 is a diagram of a structure of the communication apparatus 1000. The communication apparatus 1000 may be a terminal device, may be a chip, a chip system, a processor, or the like that supports a terminal device in implementing the foregoing methods. Alternatively, the communication apparatus 1000 may be a network device, or may be a chip, a chip system, a processor, or the like that supports a network device in implementing the foregoing methods. The apparatus may be configured to implement the methods described in the foregoing method embodiments. For details, refer to the descriptions in the foregoing method embodiments.

The communication apparatus 1000 may include one or more processors 1001. The processor 1001 may be a general-purpose processor, a dedicated processor, or the like. For example, the processor may be a baseband processor, a digital signal processor, an application-specific integrated circuit, a field programmable gate array or another programmable logic device, a discrete gate or a transistor logic device, a discrete hardware component, or a central processing unit (CPU). The baseband processor may be configured to process a communication protocol and communication data. The central processing unit may be configured to control the communication apparatus (for example, a base station, a baseband chip, a terminal, a terminal chip, a distributed unit (DU), or a central unit (CU), execute a software program, and process data of the software program.

Optionally, the communication apparatus 1000 may include one or more memories 1002, where the memory stores instructions 1004. The instructions may be run on the processor 1001, so that the communication apparatus 1000 performs the method described in the foregoing method embodiment. Optionally, the memory 1002 may further store data. The processor 1001 and the memory 1002 may be separately disposed, or may be integrated together.

The memory 1002 may include but is not limited to a non-volatile memory like a hard disk drive (HDD) or a solid-state drive (SSD), a random access memory (RAM), an erasable programmable read-only memory (EPROM), a ROM, a portable read-only memory (CD-ROM), or the like.

Optionally, the communication apparatus 1000 may further include a transceiver 1005 and an antenna 1006. The transceiver 1005 may be referred to as a transceiver unit, a transceiver machine, a transceiver circuit, or the like, and is configured to implement a transceiver function. The transceiver 1005 may include a receiver and a transmitter. The receiver may be referred to as a receiving machine, a receiver circuit, or the like, and is configured to implement a receiving function. The transmitter may be referred to as a transmitting machine, a transmitter circuit, or the like, and is configured to implement a sending function.

The communication apparatus 1000 is a terminal device. The transceiver 1005 is configured to perform S101 and S103 in the bandwidth part processing method 100, and is configured to perform S202 in the bandwidth part processing method 200. The processor 1001 is configured to perform S203 in the bandwidth part processing method 200.

The communication apparatus 1000 is a network device. The transceiver 1005 is configured to perform S101 in the bandwidth part processing method 100, and is configured to perform S202 in the bandwidth part processing method 200. The processor 1001 is configured to perform S102 in the bandwidth part processing method 100, and is configured to perform S201 in the bandwidth part processing method 200.

In another possible design, the processor 1001 may include a transceiver configured to implement receiving and sending functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In still another possible design, optionally, the processor 1001 may store instructions 1003, and the instructions 1003 are run on the processor 1001, to enable the communication apparatus 1000 to perform the method described in the foregoing method embodiment. The instructions 1003 may be fixed in the processor 1001. In this case, the processor 1001 may be implemented by hardware.

In yet another possible design, the communication apparatus 1000 may include a circuit, and the circuit may implement a sending, receiving, or communication function in the foregoing method embodiment. The processor and the transceiver described in embodiments of this application may be implemented on an integrated circuit (IC), an analog IC, a radio frequency integrated circuit (RFIC), a mixed-signal IC, an application-specific integrated circuit (ASIC), a printed circuit board (PCB), an electronic device, or the like. The processor and the transceiver may alternatively be manufactured by using various IC technologies, for example, a complementary metal oxide semiconductor (CMOS), an N-channel metal oxide semiconductor (nMetal-oxide-semiconductor, NMOS), a P-channel metal oxide semiconductor (positive channel metal oxide semiconductor, PMOS), a bipolar junction transistor (BJT), a bipolar CMOS (BiCMOS), silicon germanium (SiGe), and gallium arsenide (GaAs).

A scope of the communication apparatus described in embodiments of this application is not limited thereto, and the structure of the communication apparatus may not be limited in FIG. 10. The communication apparatus may be an independent device or may be a part of a large device. For example, the communication apparatus may be:
(1) an independent integrated circuit IC, a chip, or a chip system or subsystem;
(2) a set that has one or more ICs, where optionally, the IC set may alternatively include a storage component configured to store data and instructions;
(3) an ASIC, like a modem (modulator); or
(4) a module that can be embedded in another device.

In embodiments of this application, the communication apparatus and the chip may further perform implementations of the communication apparatus 1000. A person skilled in the art may further understand that various illustrative logical blocks and steps that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the scope of embodiments of this application.

This embodiment of this application is based on a same concept as the method embodiments shown in the bandwidth part processing method 100 and the bandwidth part processing method 200, and brings same technical effect. For a specific principle, refer to the descriptions of the embodiments shown in the bandwidth part processing method 100 and the bandwidth part processing method 200. Details are not described again.

This application further provides a computer-readable storage medium, configured to store computer software instructions. When the instructions are executed by a communication apparatus, a function in any one of the foregoing method embodiments is implemented.

This application further provides a computer program product, configured to store computer software instructions. When the instructions are executed by a communication apparatus, a function in any one of the foregoing method embodiments is implemented.

This application further provides a computer program. When the computer program is run on a computer, a function in any one of the foregoing method embodiments is implemented.

This application further provides a communication system. The system includes one or more network devices and one or more terminal devices. In another possible design, the system may further include another device that interacts with the network device and the terminal device in the solutions provided in this application.

All or some of the foregoing embodiments may be implemented by using software, hardware, firmware, or any combination thereof. When software is used to implement embodiments, all or some of embodiments may be implemented in a form of computer program product. The computer program product includes one or more computer instructions. When the computer program instructions are loaded and executed on a computer, all or some of the procedures or functions according to embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, an SSD), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method, wherein the method comprises:
sending a bandwidth part (BWP) switching request by using a first random access resource, wherein the first random access resource is any one of one or more dedicated random access resources, the first random access resource is associated with a first standby BWP set, and a coverage enhancement level of a standby BWP in the first standby BWP set is higher than a coverage enhancement level of a serving BWP of a terminal device; and
receiving first indication information, wherein the first indication information indicates a first standby BWP in the first standby BWP set.

2. The method according to claim 1, wherein:
when it is determined that the serving BWP fails or beam recovery fails, sending the bandwidth part BWP switching request by using the first random access resource; or
when a physical downlink control channel (PDCCH) is received, sending the bandwidth part BWP switching request by using the first random access resource, wherein
the PDCCH is used to trigger the terminal device to send the BWP switching request by using a dedicated random access resource.

3. The method according to claim 1, wherein the method further comprises:
receiving configuration information, wherein the configuration information comprises one or more standby BWP sets and a dedicated random access resource associated with each of the one or more standby BWP sets, wherein each of the one or more standby BWP sets comprises one or more standby BWPs.

4. The method according to claim 1, wherein
the one or more dedicated random access resources are semi-statically configured.

5. The method according to claim 1, wherein
the first indication information is carried in a random access response or downlink control information (DCI).

6. The method according to claim 1, wherein the method further comprises:
starting a first timer when the BWP switching request is sent by using the first random access resource; and
performing radio resource control (RRC) reestablishment when the first timer expires and when the first indication information is not received.

7. The method according to claim 1, wherein the method further comprises:
monitoring signal quality on the serving BWP; and
switching from the first standby BWP to the serving BWP when the signal quality on the serving BWP is better than a first preset value.

8. The method according to claim 2, wherein the method further comprises:
when signal quality on the serving BWP is less than a second preset value, determining that the serving BWP fails.

9. The method according to claim 2, wherein the method further comprises:
when the serving BWP fails and it is determined that there is no candidate beam for beam recovery, determining that the beam recovery fails.

10. An apparatus, comprising at least one processor and a transceiver, wherein the transceiver is configured to communicate with another communication apparatus, and the at least one processor and the transceiver are coupled to one or more memories storing programming instructions for execution by one or more of the at least one processor or the transceiver to perform operations comprising:
sending a bandwidth part (BWP) switching request by using a first random access resource, wherein the first random access resource is any one of one or more dedicated random access resources, the first random access resource is associated with a first standby BWP set, and a coverage enhancement level of a standby BWP in the first standby BWP set is higher than a coverage enhancement level of a serving BWP of a terminal device; and
receiving first indication information, wherein the first indication information indicates a first standby BWP in the first standby BWP set.

11. The apparatus according to claim 10, wherein:
when it is determined that the serving BWP fails or beam recovery fails, sending the bandwidth part BWP switching request by using the first random access resource; or
when a physical downlink control channel (PDCCH) is received, sending the bandwidth part BWP switching request by using the first random access resource, wherein
the PDCCH is used to trigger the terminal device to send the BWP switching request by using a dedicated random access resource.

12. The apparatus according to claim 10, wherein the operations further comprise:
receiving configuration information, wherein the configuration information comprises one or more standby BWP sets and a dedicated random access resource associated with each of the one or more standby BWP sets, wherein each of the one or more standby BWP sets comprises one or more standby BWPs.

13. The apparatus according to claim 10, wherein
the one or more dedicated random access resources are semi-statically configured.

14. The apparatus according to claim 10, wherein
the first indication information is carried in a random access response or downlink control information (DCI).

15. The apparatus according to claim 10, wherein the operations further comprise:
starting a first timer when the BWP switching request is sent by using the first random access resource; and
performing radio resource control (RRC) reestablishment when the first timer expires and when the first indication information is not received.

16. The apparatus according to claim 10, wherein the operations further comprise:
monitoring signal quality on the serving BWP; and
switching from the first standby BWP to the serving BWP when the signal quality on the serving BWP is better than a first preset value.

17. The apparatus according to claim 11, wherein the operations further comprise:
when signal quality on the serving BWP is less than a second preset value, determining that the serving BWP fails.

18. The apparatus according to claim 11, wherein the operations further comprise:
when the serving BWP fails and it is determined that there is no candidate beam for beam recovery, determining that the beam recovery fails.

19. A non-transitory computer-readable storage medium, wherein the non-transitory computer-readable storage medium is configured to store instructions for execution by at least one processor to perform operations comprising:
sending a bandwidth part (BWP) switching request by using a first random access resource, wherein
the first random access resource is any one of one or more dedicated random access resources, the first random access resource is associated with a first standby BWP set, and a coverage enhancement level of a standby BWP in the first standby BWP set is higher than a coverage enhancement level of a serving BWP of a terminal device; and
receiving first indication information, wherein the first indication information indicates a first standby BWP in the first standby BWP set.

20. The non-transitory computer-readable storage medium according to claim 19, wherein:
when it is determined that the serving BWP fails or beam recovery fails, sending the bandwidth part BWP switching request by using the first random access resource; or
when a physical downlink control channel (PDCCH) is received, sending the bandwidth part BWP switching request by using the first random access resource, wherein
the PDCCH is used to trigger the terminal device to send the BWP switching request by using a dedicated random access resource.
